(19) United States
(12) Patent Application Publication
(10) Pub. No.: US 2022/0260754 A1
(43) Pub. Date: Aug. 18, 2022

(54) IMAGING APPARATUS AND METHOD FOR MANUFACTURING THE SAME

(71) Applicant: SONY SEMICONDUCTOR SOLUTIONS CORPORATION, KANAGAWA (JP)

(72) Inventor: EIICHIRO DOBASHI, KANAGAWA (JP)

(21) Appl. No.: 17/623,719

(22) PCT Filed: Apr. 28, 2020
(86) PCT No.: PCT/JP2020/018094

§ 371 Date: Dec. 29, 2021

(30) Foreign Application Priority Data
Jul. 10, 2019 (JP) 2019-128162

(51) Int. Cl. G02B 1/00; G02B 27/00

(52) U.S. Cl. CPC G02B 1/002; G02B 27/0025

(57) ABSTRACT

Manufacturing an imaging apparatus including, in an imaging lens optical system, a function to correct aberration is facilitated. A meta-lens and an imaging element constituting the imaging apparatus are formed by a semiconductor process. The meta-lens corrects aberration in the imaging lens optical system. The imaging element images incident light incident via the imaging lens optical system. The meta-lens may be formed inside the imaging element or on a surface of the imaging element or may be formed as a part of a wafer level chip size package.

### TECHNICAL FIELD

The present technology relates to an imaging apparatus. Specifically, the present technology relates to an imaging apparatus including a meta-lens in a imaging lens optical system, and a method for manufacturing the imaging apparatus.

### BACKGROUND ART

As an imaging optical system for image detection, imaging optical systems have been developed that are used in frequency bands such as an infra-red frequency band and a terahertz frequency band as well as in a visible light region. For example, an infra-red imaging optical system utilizes heat generated from an object such as a human being or an animal, that is, utilizes far infra-red rays (a wavelength of 8 to 12 μm) and is used for image capturing in a dark place, observation of a temperature distribution, and the like. Additionally, an imaging optical system for terahertz waves (a wavelength of 30 μm to 3 mm and a frequency of 100 GHz to 10 THz) is used, for example, for what is called non-destructive inspection such as security check in airport facilities. Imaging optical systems used in these frequency bands are desired to have a high resolution in order to provide clear captured images. Thus, imaging apparatuses have been proposed that are provided with a meta-material lens for aberration correction (see, for example, PTL 1).

### CITATION LIST

### Patent Literature

### [PTL 1]

Japanese Patent No. 6164212

### SUMMARY

### Technical Problem

In the related art described above, the meta-material lens for aberration correction is provided to reduce costs. However, in this related art, a lens for aberration correction is formed separately from a semiconductor process for forming an imaging element, leading to a complicated manufacturing process.

The present technology has been developed in light of the circumstances described above, and an object of the present technology is to facilitate manufacturing of an imaging apparatus functioning to correct aberration.

### Solution to Problem

The present technology has been provided to solve the problem described above. A first aspect of the present technology provides an imaging apparatus including a meta-lens that corrects aberration in an imaging lens optical system and an imaging element that images incident light incident via the above-described imaging lens optical system, the meta-lens and the imaging element being formed by a semiconductor process. This is effective in forming, by the semiconductor process, the imaging apparatus including the meta-lens for aberration correction.

Additionally, in the first aspect, the above-described meta-lens may eliminate chromatic aberration by the above-described aberration correction.

In addition, in the first aspect, the above-described meta-lens may be formed inside the above-described imaging element or may be formed on a surface of the above-described imaging element.

Additionally, in the first aspect, the above-described meta-lens and the above-described imaging element may be formed as a wafer level chip size package including glass applied to an incident surface of the above-described imaging element and a wafer level lens formed on an incident surface of the glass. In this case, the above-described meta-lens may be formed between the above-described imaging element and the above-described glass, may be formed on the incident surface of the above-described glass, or may be formed on the incident surface of the above-described wafer level lens.

Additionally, in the first aspect, the above-described meta-lens may have a target wavelength ranging from a terahertz wavelength to an ultraviolet wavelength.

In addition, in the first aspect, the above-described meta-lens may have a pillar structure or a hole structure.

In addition, in the first aspect, the above-described meta-lens may include a dielectric substance as a material. For example, the above-described meta-lens may include at least one material included in TiO2, SiO2, α-Si, SiN, TiN, SiON, and TiON.

Additionally, in the first aspect, the above-described meta-lens may include a light shielding film outside an effective optical range. This is effective in preventing reflection of light.

In addition, a second aspect of the present technology is a method for manufacturing an imaging apparatus, the method including the steps of forming, by the semiconductor process, an imaging element that images incident light incident via an imaging lens optical system and forming, by the semiconductor process, a meta-lens that corrects aberration in the above-described imaging lens optical system. This is effective in forming, by the semiconductor process, the imaging apparatus including the meta-lens for aberration correction.

Additionally, in a second aspect, the above-described meta-lens may be embedded when glass of a wafer level chip size package is laminated to a wafer.

In addition, in the second aspect, the above-described meta-lens may be diced simultaneously with dicing of a wafer level chip size package.

Additionally, in the second aspect, the above-described meta-lens may be formed on a surface of the wafer level lens by imprinting when the wafer level lens is formed immediately above a wafer level chip size package.

In addition, in the second aspect, the above-described meta-lens may be embedded in a wafer level lens when the above-described wafer level lens is formed after the above-described meta-lens is formed on an upper surface of glass of a wafer level chip size package.

### BRIEF DESCRIPTION OF DRAWINGS

FIG. 1 is a diagram depicting a configuration example of an imaging apparatus in a first embodiment of the present technology.

FIG. 2 is a diagram depicting arrangement examples of a meta-lens 610 in the first embodiment of the present technology.

FIG. 3 is a diagram depicting a first structure example of the meta-lens 610 in the first embodiment of the present technology.

FIG. 4 is a diagram depicting a second structure example of the meta-lens 610 in the first embodiment of the present technology.

FIG. 5 is a diagram depicting a configuration example of an imaging apparatus in a second embodiment of the present technology.

FIG. 6 is a diagram depicting first arrangement examples of the meta-lens 610 in the second embodiment of the present technology.

FIG. 7 is a diagram depicting second arrangement examples of the meta-lens 610 in the second embodiment of the present technology.

FIG. 8 is a diagram depicting an example of steps of replica formation in the process of manufacturing an imaging apparatus according to the second embodiment of the present technology.

FIG. 9 is a diagram depicting an example of steps of lens formation in the process of manufacturing an imaging apparatus according to the second embodiment of the present technology.

FIG. 10 is a diagram depicting an example of steps focused on a wafer state in the process of manufacturing an imaging apparatus according to the second embodiment of the present technology.

### DESCRIPTION OF EMBODIMENTS

Modes for implementing the present technology (hereinafter referred to as embodiments) will be described below. Description is in the following order.

1. First Embodiment (an example in which a meta-lens is formed on an imaging element)

2. Second Embodiment (an example in which a meta-lens is formed on a chip size package)

### 1. First Embodiment

### [Imaging Apparatus]

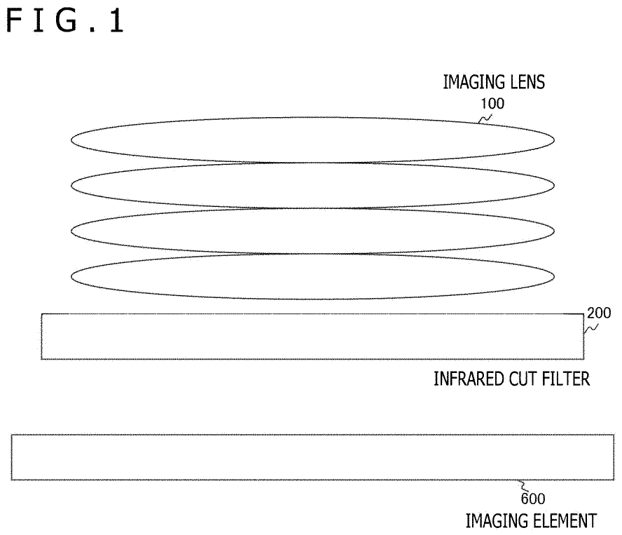

FIG. 1 is a diagram depicting a configuration example of an imaging apparatus in a first embodiment of the present technology.

The imaging apparatus in the first embodiment includes an imaging lens 100, an infra-red cut filter (IRCF) 200, and an imaging element 600.

The imaging lens 100 is an imaging lens optical system for providing incident light to the imaging element 600. The imaging lens 100 normally includes a plurality of lenses combined together depending on required performance. Additionally, lens groups may be configured for respective functions to provide a zoom function and a focus function.

The infra-red cut filter 200 is a filter that removes light rays in wavelength regions of a wavelength larger than that of red (in other words, regions having a low frequency), the light rays being included in incident light from the imaging lens 100. The infra-red cut filter 200 may be omitted depending on the intended use of the imaging apparatus.

The imaging element 600 is a sensor that images incident light from the imaging lens 100 and is implemented by, for example, a complementary metal oxide semiconductor (CMOS) image sensor (CIS).

Note that the imaging apparatus may further include a cover (not illustrated) for protection.

### [Arrangement of Meta-Lens]

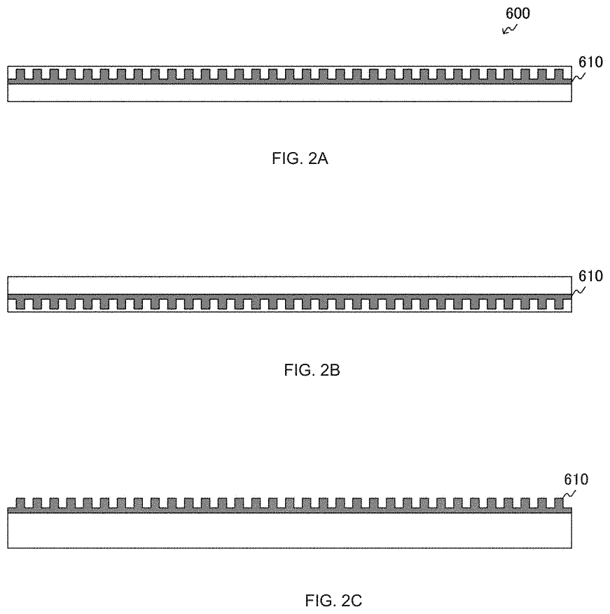

FIG. 2 is a diagram depicting arrangement examples of a meta-lens 610 in the first embodiment of the present technology.

In the imaging apparatus in the first embodiment, the meta-lens 610 is formed as a part of the imaging element 600 by a semiconductor process. Specifically, in a process of microfabricating a silicon wafer, the meta-lens 610 is formed as a part of the imaging element 600.

For example, as depicted at “a” in FIG. 2, the meta-lens 610 may be provided inside an upper side of the imaging element 600. Alternatively, as depicted at “b” in FIG. 2, the meta-lens 610 may be provided inside a lower side of the imaging element 600. Alternatively, as depicted at “c” in FIG. 2, the meta-lens 610 may be provided on a surface of the imaging element 600 such as an upper surface of the imaging element 600.

By forming the meta-lens 610 as a part of the imaging element 600 as described above, aberration in an optical system of the imaging lens 100 can be corrected. The aberration is assumed to be, for example, a chromatic aberration such as an axial chromatic aberration or a lateral chromatic aberration, or a monochromatic aberration such as a spherical aberration, an astigmatism aberration, a coma aberration, a field curvature aberration, or a distortion aberration.

The meta-lens 610 is assumed to have, for example, a target wavelength ranging from a terahertz wavelength (a wavelength ranging from 30 μm to 3 mm and a frequency ranging from 100 GHz to 10 THz) to an ultraviolet wavelength (ultraviolet rays are light rays having a wavelength smaller than that of purple (a wavelength of 380 nm)).

A material for the meta-lens 610 is desirably a dielectric substance. Specifically, at least one material such as in TiO2, SiO2, α-Si, SiN, TiN, SiON, TiON, or the like is assumed.

Additionally, parts of the meta-lens 610 outside an effective optical range may be blackened. Specifically, for prevention of light reflection, the meta-lens 610 may include a light shielding film functioning as a fixed aperture.

### [Structure of Meta-Lens]

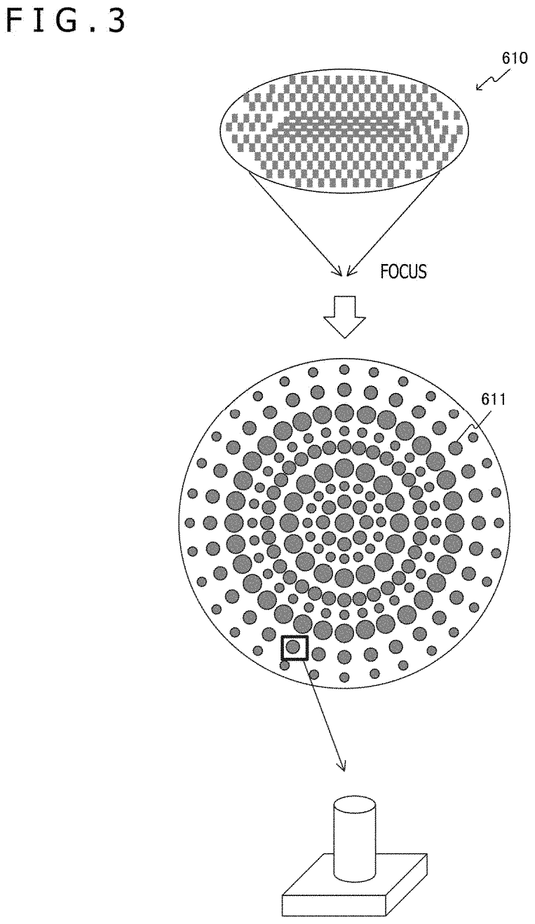

FIG. 3 is a diagram depicting a first structure example of the meta-lens 610 in a first embodiment of the present technology.

In the first structure example of the meta-lens 610, the single meta-lens has a pillar structure 611. In other words, the meta-lens 610 includes a plurality of fine pillar structures 611 arranged on a flat surface and having heights and widths in nano order to form a dielectric substance with an optional permittivity.

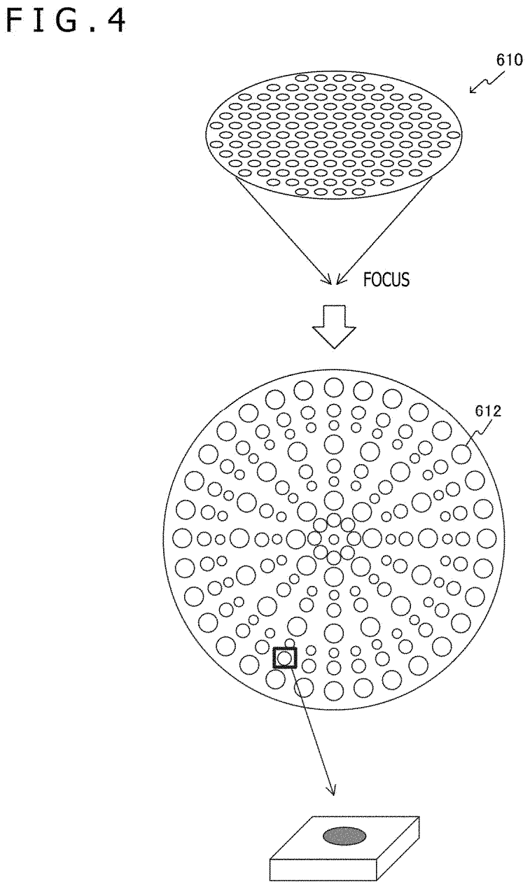

FIG. 4 is a diagram depicting a second structure example of the meta-lens 610 in the first embodiment of the present technology.

In the second structure example of the meta-lens 610, the single meta-lens has a hole structure 612. In other words, the meta-lens 610 includes a plurality of fine hole structures 612 arranged on a flat surface and having depths and widths in nano order to form a dielectric substance with an optional permittivity.

Thus, according to the first embodiment of the present technology, manufacturing of the imaging apparatus can be facilitated by forming the meta-lens 610 for aberration correction as a part of the imaging element 600 by the semiconductor process. In a case where a separate lens is added to the imaging lens optical system for aberration correction, the optical total length is increased. However, by forming the meta-lens 610 as a part of the imaging element 600 as in the first embodiment, the optical total length can be reduced to miniaturize the imaging apparatus.

### 2. Second Embodiment

### [Imaging Apparatus]

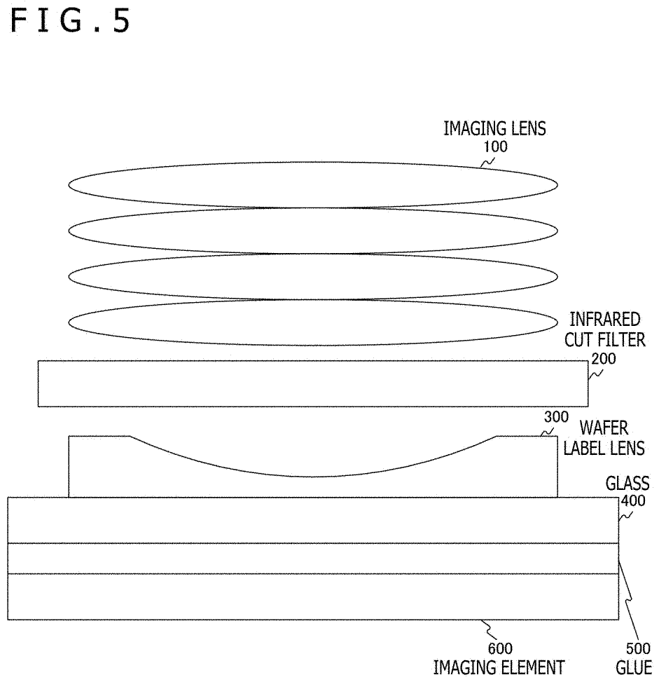

FIG. 5 is a diagram depicting a structure example of an imaging apparatus in a second embodiment of the present technology.

The imaging apparatus in the second embodiment is formed as a wafer level chip size package (CSP). Specifically, glass 400 is loaded on the imaging element 600 via a glue 500 used as an adhesive, and a wafer level lens 300 is formed on the glass 400. These components are formed into a package by the semiconductor process such that the components remain in a wafer state.

The wafer level lens 300 is a lens formed at a wafer level as a part of the wafer level chip size package by the semiconductor process. The wafer level lens 300 is formed by, for example, ultraviolet (UV) irradiation as described below, and as a material in that case, a UV curing resin is used.

Note that the imaging lens 100, the infra-red cut filter 200, and the imaging element 600 are similar to those in the first embodiment described above.

### [Arrangement of Meta-Lens]

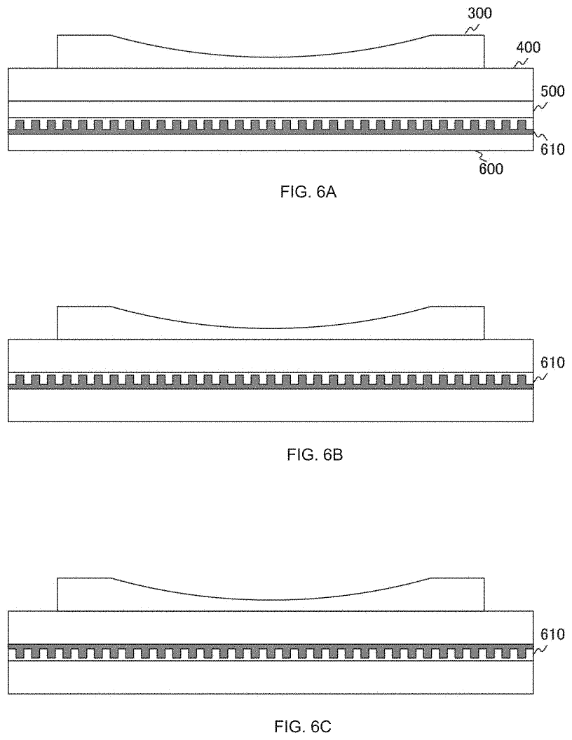

FIG. 6 is a diagram depicting first arrangement examples of the meta-lens 610 in the second embodiment of the present technology.

In the arrangement example in the second embodiment, the meta-lens 610 is formed as a part of the wafer level chip size package by the semiconductor process. Specifically, in the process of microfabricating the silicon wafer, the meta-lens 610 is formed as a part of the wafer level chip size package.

For example, as depicted at “a” in FIG. 6, the meta-lens 610 may be provided inside the imaging element 600. Alternatively, as depicted at “b” in FIG. 6, the meta-lens 610 may be provided on an upper surface of the imaging element 600, and embedded in the glue 500 when the glass 400 is laminated to the wafer. Alternatively, as depicted at “c” in FIG. 6, the meta-lens 610 may be provided on a lower surface of the glass 400, and embedded in the glue 500 when the glass 400 is laminated to the wafer. In other words, in an example “b” or “c” in FIG. 6, the meta-lens 610 is formed between the imaging element 600 and the glass 400.

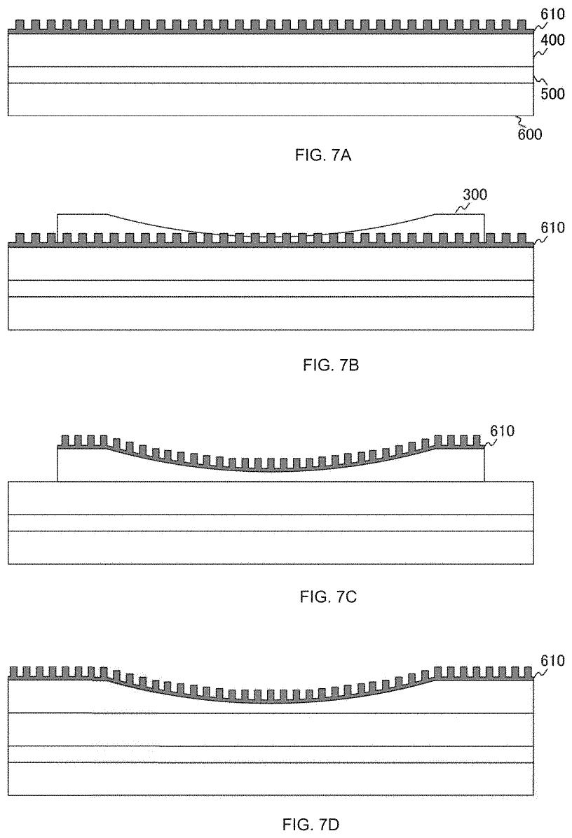

FIG. 7 is a diagram depicting second arrangement examples of the meta-lens 610 in the second embodiment of the present technology.

For example, as depicted at “a” and “b” in FIG. 6, the meta-lens 610 may be provided on an incident surface of the glass 400, and the wafer level lens 300 may be formed on the meta-lens 610. In this case, after being formed on an upper surface of the glass 400, the meta-lens 610 is embedded into the wafer level lens 300 during formation of the wafer level lens 300.

Alternatively, as depicted at “c” or “d” in FIG. 7, the meta-lens 610 may be formed on an incident surface of the wafer level lens 300. “c” in FIG. 7 is an example in which the wafer level lens 300 is formed after dicing of the wafer level chip size package, and “d” in FIG. 7 is an example in which the wafer level lens 300 is formed before dicing of the wafer level chip size package. In these cases, the meta-lens 610 is formed on the surface of the wafer level lens 300 by imprinting when the wafer level lens 300 is formed immediately above the wafer level chip size package. Alternatively, in a case of an example “d” in FIG. 7, the meta-lens 610 is diced simultaneously with dicing of the wafer level chip size package.

Note that, for the structure of the meta-lens 610, the pillar structure 611 and the hole structure 612 are assumed as is the case with the first embodiment as described above. Additionally, the material for the meta-lens 610 is similar to the material for the meta-lens in the first embodiment.

### [Manufacturing Method]

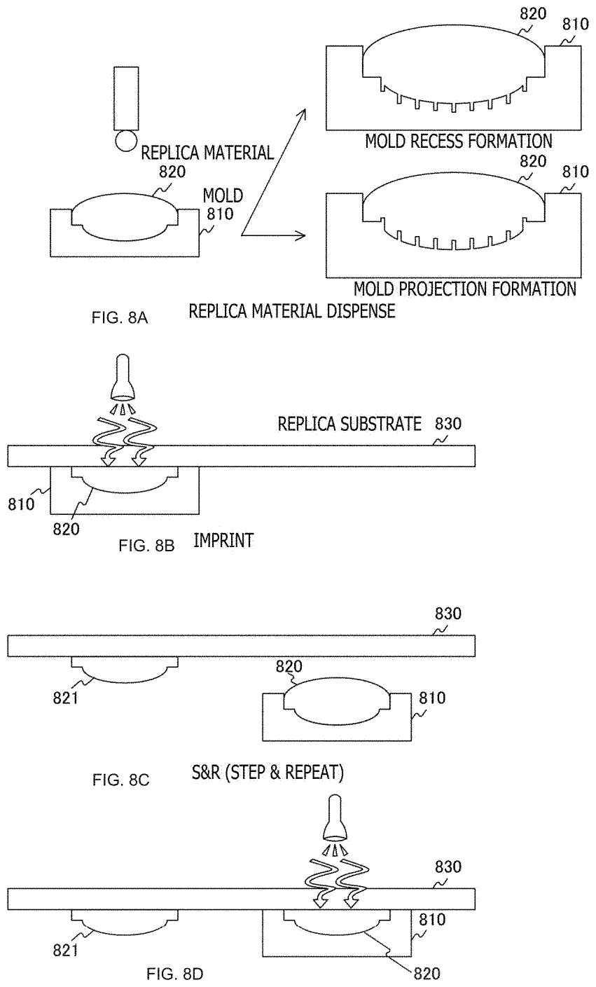

FIG. 8 is a diagram depicting an example of a procedure of replica formation in the process of manufacturing an imaging apparatus in the second embodiment of the present technology.

First, as depicted at “a” in FIG. 8, a dispenser is used to dispense a replica material 820 into a mold 810. As the mold 810, a mold is used that has a recessed shape or a projecting shape depending on the shape of structure of the meta-lens 610 to be formed. In this case, for example, a UV curing resin is used as the replica material 820.

Then, as depicted at “b” in FIG. 8, the replica substrate 830 is overlaid on an upper surface of the mold 810 into which the replica material 820 has been dispensed. This causes the replica material 820 having a shape corresponding to the mold 810 to be imprinted on the replica substrate 830. In this case, as a material for the replica substrate 830, for example, quartz is used.

As depicted at “c” in FIG. 8, when the mold 810 is removed from the replica material 820 completely imprinted, a replica 821 is formed. Then, the replica material 820 is dispensed for the next replica formation, and imprinting is repeated as depicted at “d” in FIG. 8. In such a manner, the replicas 821 are sequentially formed on the replica substrate 830.

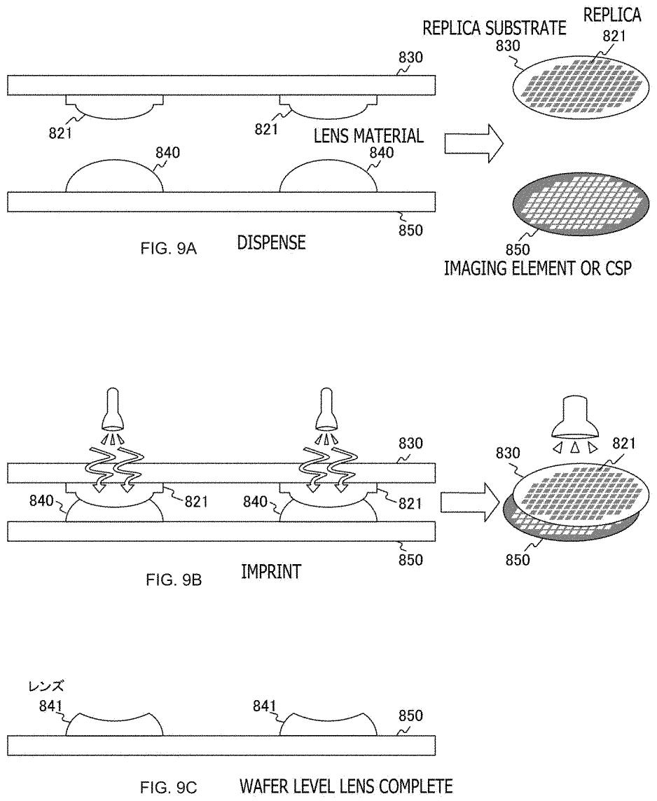

FIG. 9 is a diagram depicting an example of steps of lens formation in the process of manufacturing an imaging apparatus in the second embodiment of the present technology.

As depicted at “a” in FIG. 9, lens materials 840 are dispensed onto the upper surface of an imaging element or a wafer level chip size package 850. In this case, for example, a UV curing resin is used as the lens material 840. Note that, in the steps described below, the arrangement of the imaging element or the wafer level chip size package 850 and the replica substrate 830 may be turned upside down. In other words, the replica substrate 830 may be located on the lower side, whereas the imaging element or the wafer level chip size package 850 may be located on the upper side.

Then, as depicted at “b” in FIG. 9, the replica substrate 830 is overlaid on the wafer level chip size package 850 such that the lens materials 840 are aligned with the replicas 821.

Then, as depicted at “c” in FIG. 9, when the replica substrate 830 is removed, lenses 841 are formed. The lens 841 is the above-described wafer level lens 300, and the meta-lens 610 is formed on the upper surface of the wafer level lens 300.

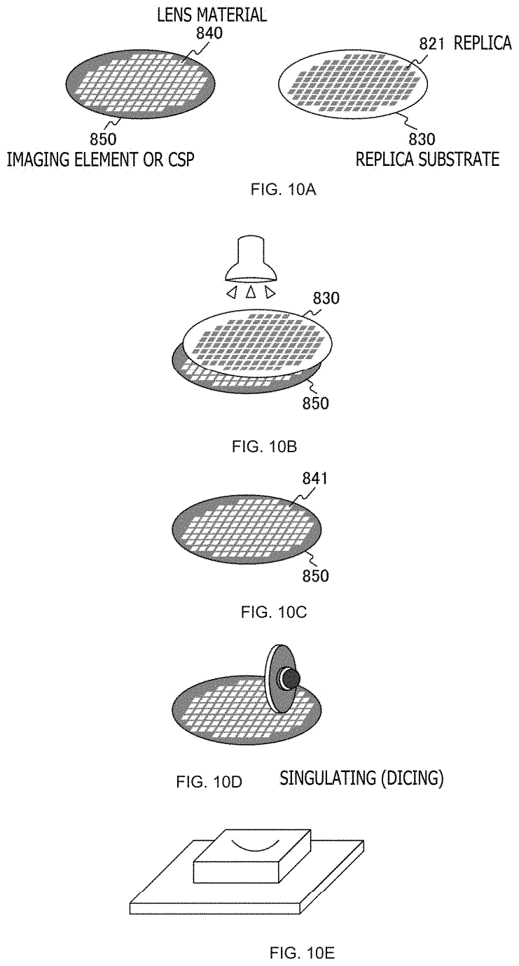

FIG. 10 is a diagram depicting an example of steps focused on a wafer state in the process of manufacturing an imaging apparatus in the second embodiment of the present technology.

As depicted at “a” in FIG. 10, the replica substrate 830 is prepared on which the replicas 821 are formed, and the imaging element or the wafer level chip size package 850 is also prepared on which the lens materials 840 have been dispensed.

Then, as depicted at “b” in FIG. 10, the replica substrate 830 is overlaid on the imaging element or the wafer level chip size package 850 such that the lens materials 840 are aligned with the replicas 821, and ultraviolet rays are radiated to the replica substrate 830 from above the replica substrate 830. Thus, as depicted at “c” in FIG. 10, the lenses 841 are formed.

The imaging element or the wafer level chip size package 850 on which the lenses 841 are formed is singulated (diced) as depicted at “d” in FIG. 10. Thus, a single imaging apparatus is formed as depicted at “e” in FIG. 10.

Thus, according to the second embodiments of the present technology, manufacturing of the imaging apparatus can be facilitated by forming the meta-lens 610 for aberration correction as a part of the wafer level chip size package by the semiconductor process.

Note that the above-described embodiments are examples for realizing the present technology and that matters in the embodiments each correspond to invention-specific matters in claims. Similarly, the invention-specific matters in the claims each correspond to the matters in the embodiments of the present technology. However, the present technology is not limited to the embodiments and can be realized by making various modifications to the embodiments without departing from the spirits of the present technology.

Additionally, the processing steps described above in the embodiments may be taken as a method including the series of steps or as a program for causing a computer to execute the series of steps or a recording medium in which the program is recorded. As the recording medium, for example, a CD (Compact Disc), an MD (MiniDisc), a DVD (Digital Versatile Disc), a memory card, or a Blue-ray (registered trademark) disc can be used.

Note that the effects described herein are only illustrative and not restrictive and that other effects may be produced.

Note that the present technology can also take the following configurations.

(1)

An imaging apparatus including:

a meta-lens that corrects aberration in an imaging lens optical system, and

an imaging element that images incident light incident via the above-described imaging lens, the meta-lens and the imaging element being formed by a semiconductor process.

(2)

The imaging apparatus according to (1) described above, in which

the above-described meta-lens eliminates chromatic aberration by the above-described aberration correction.

(3)

The imaging apparatus according to (1) or (2) described above, in which

the above-described meta-lens is formed inside the above-described imaging element.

(4)

The imaging apparatus according to (1) or (2) described above, in which

the above-described meta-lens is formed on a surface of the above-described imaging element.

(5)

The imaging apparatus according to (1) or (2) described above, in which

the above-described meta-lens and the above-described imaging element are formed as a wafer level chip size package including glass applied to an incident surface of the above-described imaging element and a wafer level lens formed on an incident surface of the glass.

(6)

The imaging apparatus according to (5) described above, in which

the above-described meta-lens is formed between the above-described imaging element and the above-described glass.

(7)

The imaging apparatus according to (5) described above, in which

the above-described meta-lens is formed on the incident surface of the above-described glass.

(8)

The imaging apparatus according to (5) described above, in which

the above-described meta-lens is formed on the incident surface of the above-described wafer level lens.

(9)

The imaging apparatus according to any one of (1) to (8) described above, in which

the above-described meta-lens has a target wavelength ranging from a terahertz wavelength to an ultraviolet wavelength.

(10)

The imaging apparatus according to any one of (1) to (9) described above, in which

the above-described meta-lens has a pillar structure or a hole structure.

(11)

The imaging apparatus according to any one of (1) to (10) described above, in which

the above-described meta-lens includes a dielectric substance as a material.

(12)

The imaging apparatus according to any one of (1) to (11) described above, in which

the above-described meta-lens includes at least one material included in TiO2, SiO2, α-Si, SiN, TiN, SiON, and TiON.

(13)

The imaging apparatus according to any one of (1) to (12) described above, in which

the above-described meta-lens includes a light shielding film outside an effective optical range.

(14)

A method for manufacturing an imaging apparatus, the method including the steps of:

forming, by a semiconductor process, an imaging element that images incident light incident via an imaging lens optical system, and

forming, by the semiconductor process, a meta-lens that corrects aberration in the above-described imaging lens optical system.

(15)

The method for manufacturing an imaging apparatus, according to (14) described above, in which

the above-described meta-lens is embedded when glass of a wafer level chip size package is laminated to a wafer.

(16)

The method for manufacturing an imaging apparatus, according to (14) described above, in which

the above-described meta-lens is diced simultaneously with dicing of a wafer level chip size package.

(17)

The method for manufacturing an imaging apparatus, according to (14) described above, in which

the above-described meta-lens is formed on a surface of the wafer level lens by imprinting when the wafer level lens is formed immediately above a wafer level chip size package.

(18)

The method for manufacturing an imaging apparatus, according to (14) described above, in which

the above-described meta-lens is embedded in a wafer level lens when the above-described wafer level lens is formed after the above-described meta-lens is formed on an upper surface of glass of a wafer level chip size package.

### REFERENCE SIGNS LIST

100: Imaging lens
200: Infra-red cut filter (IRCF)
300: Wafer level lens
400: Glass
500: Glue
600: Imaging element
610: Meta-lens
611: Pillar structure
612: Hole structure
810: Mold
820: Replica material
821: Replica
830: Replica substrate
840: Lens material
841: Lens
850: Imaging element or wafer level chip size package

1. An imaging apparatus comprising:
a meta-lens that corrects aberration in an imaging lens optical system, and
an imaging element that images incident light incident via the imaging lens optical system, the meta-lens and the imaging element being formed by a semiconductor process.

2. The imaging apparatus according to claim 1, wherein
the meta-lens eliminates chromatic aberration by the aberration correction.

3. The imaging apparatus according to claim 1, wherein
the meta-lens is formed inside the imaging element.

4. The imaging apparatus according to claim 1, wherein
the meta-lens is formed on a surface of the imaging element.

5. The imaging apparatus according to claim 1, wherein
the meta-lens and the imaging element are formed as a wafer level chip size package including glass applied to an incident surface of the imaging element and a wafer level lens formed on an incident surface of the glass.

6. The imaging apparatus according to claim 5, wherein
the meta-lens is formed between the imaging element and the glass.

7. The imaging apparatus according to claim 5, wherein
the meta-lens is formed on the incident surface of the glass.

8. The imaging apparatus according to claim 5, wherein
the meta-lens is formed on an incident surface of the wafer level lens.

9. The imaging apparatus according to claim 1, wherein
the meta-lens has a target wavelength ranging from a terahertz wavelength to an ultraviolet wavelength.

10. The imaging apparatus according to claim 1, wherein
the meta-lens has a pillar structure or a hole structure.

11. The imaging apparatus according to claim 1, wherein
the meta-lens includes a dielectric substance as a material.

12. The imaging apparatus according to claim 1, wherein
the meta-lens includes at least one material included in TiO2, SiO2, α-Si, SiN, TiN, SiON, and TiON.

13. The imaging apparatus according to claim 1, wherein
the meta-lens includes a light shielding film outside an effective optical range.

14. A method for manufacturing an imaging apparatus, the method comprising the steps of:
forming, by a semiconductor process, an imaging element that images incident light incident via an imaging lens optical system, and
forming, by the semiconductor process, a meta-lens that corrects aberration in the imaging lens optical system.

15. The method for manufacturing an imaging apparatus according to claim 14, wherein
the meta-lens is embedded when glass of a wafer level chip size package is laminated to a wafer.

16. The method for manufacturing an imaging apparatus according to claim 14, wherein
the meta-lens is diced simultaneously with dicing of a wafer level chip size package.

17. The method for manufacturing an imaging apparatus according to claim 14, wherein
the meta-lens is formed on a surface of a wafer level lens by imprinting when the wafer level lens is formed immediately above a wafer level chip size package.

18. The method for manufacturing an imaging apparatus according to claim 14, wherein
the meta-lens is embedded in a wafer level lens when the wafer level lens is formed after the meta-lens is formed on an upper surface of glass of a wafer level chip size package.
